(19) United States
(12) Patent Application Publication
(10) Pub. No.: US 2008/0073809 A1
(43) Pub. Date: Mar. 27, 2008

(54) MULTI-PIECE SPORTS BALL

(76) Inventors: KYLE LARRY LAMSON, CHELMSFORD, ME (US); ALEXANDER REYNOLDS, WAYLAND, ME (US)

Correspondence Address: Dickinson Wright PLLC, 38525 Woodward Avenue, Suite 2000, Bloomfield Hills, MI, 48304, US

(21) Appl. No.: 11/535,193

(22) Filed: Sep. 26, 2006

(51) Int. Cl. B29C 39/10; B29C 39/12

(52) U.S. Cl. 264/129; 264/279; 264/247

(57) ABSTRACT

A multi-piece sports ball that consists of two or more pieces coupled together to form a solid circular shape. Each of the pieces includes a rounded outer surface corresponding to a portion of the outer circumference of the ball. The first of the two or more pieces is formed in a desired shape and a desired color and of a desired composition, while the additional piece or pieces are each formed having their own desired markings and coupled to the first piece such that at least a portion of each of the two or more pieces forms a portion of the outer circumference of the sports ball. A pour molding or injection molding process preferably forms the multi-piece sports ball.

### TECHNICAL FIELD

The present invention relates generally to a sports ball. More particularly, the present invention relates generally to a multi-piece sports ball for use in the game of lacrosse.

### BACKGROUND OF THE INVENTION

Many current sports balls, such as lacrosse balls, are made from a synthetic or natural rubber material of a one-piece and one-color construction and typically have a smooth outer surface. Deviations from the smooth outer surface typically found on the balls include a parting line around the equator of the ball and any markings such as color patterns, numbering, lettering, shapes, and logos or other indicia (collectively “markings”). These markings are typically introduced within or onto the outer surface as the ball is formed or otherwise may added to the ball in a post-manufacturing step. These markings are important to manufacturers for many reasons. For example, manufacturers use logos and like markings as source identifiers for identifying and marketing their products. In addition, some markings are added for aesthetic reasons, while other markings are added for functional purposes.

However, the introduction of markings to the outer surface of the balls in these manners has their drawbacks. For example, the introduction markings, either protruding outward or protruding inward, affect the overall roundness of the ball, and hence its playability. Moreover protruding markings tend to wear off during usage of the ball, leaving the ball unidentifiable as to its source or origin. Further, when markings are formed within the outer surface in order to limit deviations to the roundness of the ball, they are not typically readily visible to the user.

In alternative arrangements, markings may be painted or otherwise applied to the outer surface of the sports ball either during or after manufacturing. However, similar to protruding markings, painted-on markings have a tendency to wear off as the sports ball is used in play or practice, thus leaving the sports ball unidentifiable as to its source or origin.

Additionally, lacrosse balls have recently been introduced that have a textured surface for improved aerodynamic characteristics. This textured surface is also introduced into or onto the surface of the ball during the manufacturing process. The texture is usually applied uniformly over the surface of the ball. Thus, to the extent a portion of the textured surface wears off or wears down, it can affect the performance of the ball.

Therefore, a need exists for a sports ball having prominently displayed markings that are easily applied to or formed as a part of the lacrosse ball during manufacturing.

### SUMMARY OF THE INVENTION

The present invention provides a sports ball, including for example a lacrosse ball, which consists of two or more pieces coupled together to form a solid circular shape. Each of the pieces includes a rounded outer surface corresponding to a portion of the outer circumference of the ball. The first of the two or more pieces is formed in a desired shape, of a desired color and of a desired composition (i.e. having desired markings), while the additional piece or pieces are each formed having their own desired markings and coupled to the first piece such that at least a portion of each of the two or more pieces forms a portion of the outer circumference of the sports ball.

To form the sports ball, one of the at least two pieces is formed in a desired shape and a desired color by either pour molding or injection molding a molten raw material of a desired composition and color within a mold and cooling it to a desired shape that includes a rounded outer surface. The desired shape could be a circle, letter, number, or any other shape desired by the manufacturer. The first piece is removed from the mold and placed into a spherical mold such that the rounded outer surface of the first piece corresponds to the outer circumference of a portion of the spherical mold. A second molten material of a desired composition and color is then introduced via a pour molding or injection molding technique into the spherical mold to fill the mold. The molten material is cooled, therein forming the ball with the two distinctly formed pieces.

As one of ordinary skill will appreciate, a sports ball that includes three or more pieces can be formed with slight modifications to the preferred method described above by either introducing two or more pieces within the spherical mold prior to introduction of the second molten material or by alternatively only partially filling the spherical mold with a second piece, cooling the second portion, and filling the rest of the spherical mold with a third distinct molten material having a desired composition and color and allowing the third piece to cool. As with the two-piece ball, the molten materials may be preferably introduced to the mold via a pour molding or injection molding technique.

In another alternative embodiment, a portion of the outer surface of the formed sports ball could be painted in a post-manufacturing step with a paint to form at least one marking on one or more of the two or more formed pieces located along the outer circumference.

The present invention thus has many advantages over conventional one-piece, single color balls. First, the multi-colored sports balls may be formed without the need for nonuniform protruding regions or indentions, thus improving playability of the balls. In addition, because the varying colors of the balls are integrated into the composition of the balls, as opposed to having colors painted on the ball in a post-manufacturing step, the integrated colors will resist wear and degradation. Moreover, the introduction of colors may be done in a virtually limitless number of ways, therein making the balls ideally suited for decorative, training, advertising, and/or any other intended aesthetic purpose in addition to their normal sports usages.

Other advantages of the present invention will become apparent when viewed in light of the detailed description of the preferred embodiment when taken in conjunction with the attached drawings and appended claims.

### BRIEF DESCRIPTION OF THE DRAWINGS

For a more complete understanding of this invention, reference should now be made to the embodiments illustrated in greater detail in the accompanying drawings and described below by way of examples of the invention:

FIG. 1 is a perspective view of a two-piece sports ball according to a preferred embodiment of the present invention;

FIG. 2 is an exploded view of the sports ball of FIG. 1;

FIGS. 3A-B are section views of a pour mold used for forming one of the pieces of a two-piece sports ball in accordance with one preferred embodiment of the present invention;

FIG. 3C is a perspective view of the two-piece sports ball formed with the pour mold of FIGS. 3A and 3B;

FIGS. 4A-C are section views of a spherical injection mold used to form the two-piece sports ball in accordance with one preferred embodiment of the present invention;

FIG. 4D is a perspective view of the two-piece sports ball formed with the injection mold of FIGS. 4A and 4B and 4C;

FIG. 5 is a section view of a spherical pour mold used to form a three-piece sports ball in accordance with another preferred embodiment of the present invention; and

FIG. 6 is a section view of a spherical injection mold used to form a three-piece sports ball in accordance with another preferred embodiment of the present invention.

### DETAILED DESCRIPTION OF THE PREFERRED EMBODIMENT

In the following figures, the same reference numerals are used to identify the same components in the various views.

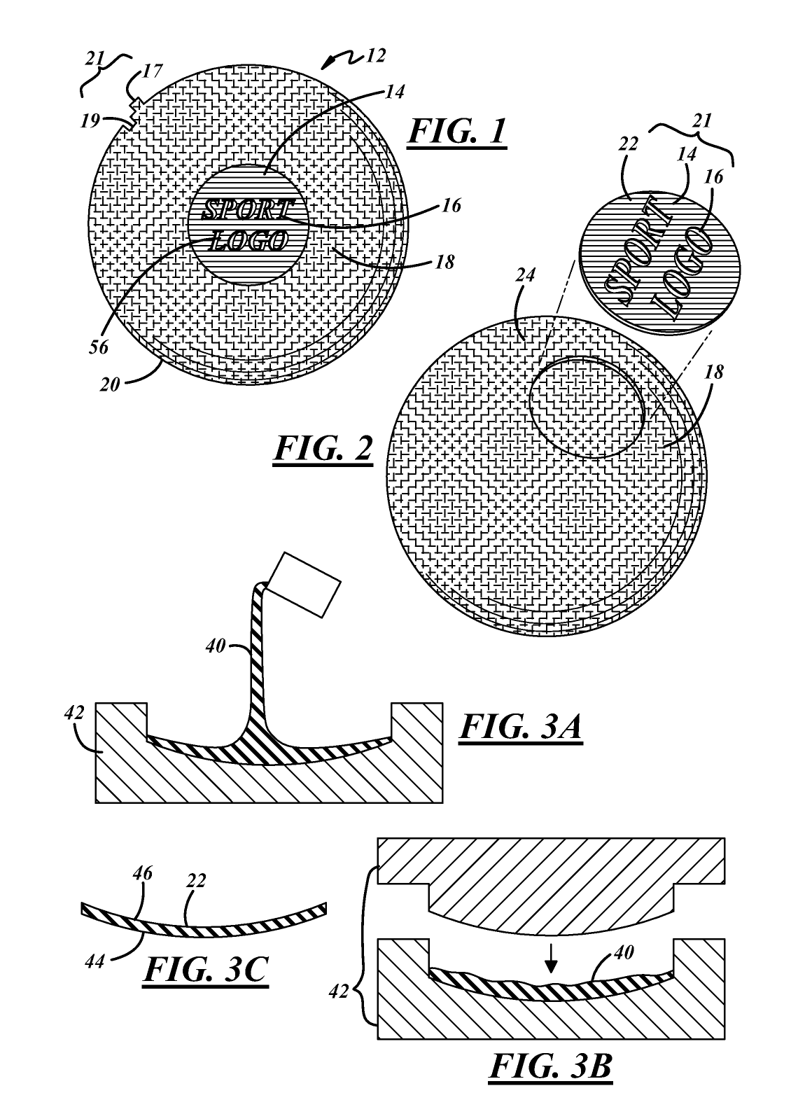

Referring to FIGS. 1-2, a substantially spherical multi-piece sports ball, here a two-piece lacrosse ball 12, formed in accordance with a preferred embodiment of the present invention is illustrated as having a number of different colored regions 14, 16, 18 displayed on the outer visible surface 20 on the sports ball 12. While a two-piece lacrosse ball is illustrated in this embodiment, it will be understood that a multi-piece ball can be formed with more than two pieces as desired. The preferred embodiments are described in connection with a lacrosse ball. However, it will be understood that the ball may be utilized for a variety of activities.

The two-piece lacrosse ball 12 includes two separate pieces 22, 24 that are coupled together as and function as an integral spherical unit. The first piece 22 includes two different colored regions 14 and 16, here illustrated as blue and white, while the second piece 24 includes another colored region 18, here shown as yellow. The outer visible surface 20 of the ball 12 may include protrusions 17 and/or indentations 19. Collectively, the colored regions 14, 16, 18, the protrusions 17, and the indentations 19 may be referred to as markings 21. Markings 21 that may be used on lacrosse balls 12 include, but are not limited to, color patterns, numbering, lettering, shapes, and logos or other indicia. Additionally, the outer surface 15 of the ball 12 may also have a texture formed thereon to provide improved aerodynamics and/or non-skid properties to the ball 12.

For a lacrosse ball 12 capable of being used in play and in accordance with current NCAA and other professional governing body rules, each of the pieces 22, 24 are required to be formed of synthetic or natural rubber. For other sports or recreational uses, the choice of materials used in the sports balls is not so limited, and may include other elastomeric materials other than synthetic rubber or natural rubber, or other non-elastomeric materials as one of ordinary skill in the art may contemplate. The composition of materials used in the first piece 22 may be the same as used for the second piece 24, or may be different, with the only requirement being that the coupled pieces have sufficient adherence to one another to function as if they were one piece during usage of the ball.

FIGS. 3A-C and 4A-D show one preferred method for forming the two-piece sports ball 12. Referring first to FIGS. 3A and 3B, the first piece 22 of the at least two pieces is formed in a desired shape and a desired color by pour molding a molten raw material 40 of a first composition within a mold 42 and cooling it to a desired shape that includes a rounded outer surface 44 and an inner surface 46. The desired shape could be a circle, letter, number, or any other shape desired by the manufacturer. Thereafter, as shown in FIG. 3C, the first piece 22 is removed from the mold 42.

In an alternative preferred method (not shown), the first piece 22 may be formed via an injection molding technique, wherein the molten raw material 40 is injected within a mold at a desired temperature and pressure to fill the mold. The molten raw material 40 is allowed to cool, and the first piece is then removed from the mold.

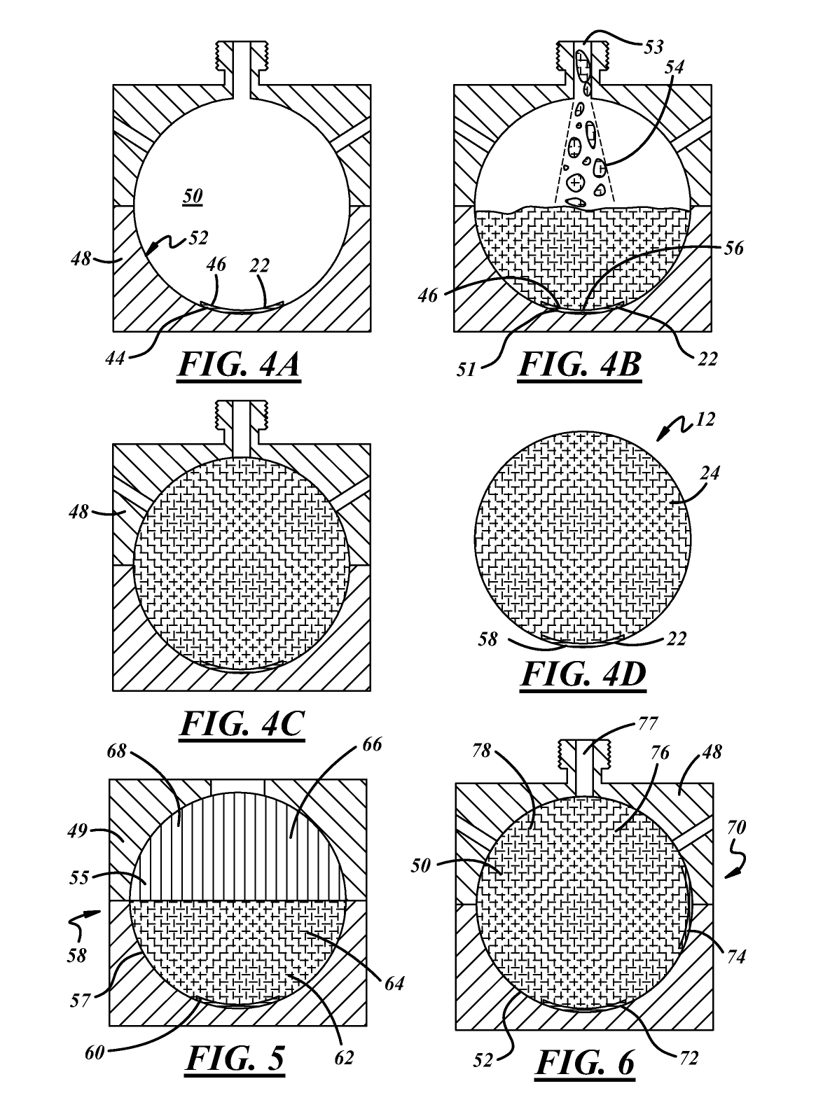

Next, as shown in FIG. 4A, the first piece 22 is placed into a spherical injection mold 48 having an inner cavity 50 such that rounded outer surface 44 of the first piece 22 substantially abuts a portion 51 of the outer circumference 52 of the cavity 50. Next, as shown in FIGS. 4B and 4C, a second portion of a molten raw material 54 of a second composition is then injected into the spherical injection mold 48 to fill the cavity 50 and allowed to cool, therein forming the second piece 24. A series of one or more injection ports 53 are utilized to inject the molten raw material 54 at a desired temperature and pressure to fill the cavity 50. A portion 56 of the molten raw material 54 contacts the inner surface 46 of the first piece 22 and is adhered to the inner surface 46 as the molten raw material 54 is cooled. The lacrosse ball 12 is then removed from the spherical injection mold 48 and is available for use.

Alternatively, the lacrosse ball may be formed using a pour molding technique (not shown) similar to the injection molding technique of FIG. 4, in which the molten raw material 54 is simply poured into a spherical mold having the first piece 22 previously placed therein such that rounded outer surface 44 of the first piece 22 substantially abuts a portion of the outer circumference of the cavity. The molten raw material 54 is cooled as in the mold and then removed to make the ball available for use.

The composition of molten raw material 54 may be the same as the molten raw material 40. Alternatively, the composition of the molten raw material 54 may be different that that of the molten raw material 40, depending upon the ultimate characteristics of the lacrosse ball desired. For example, a lacrosse ball 12 meeting current NCAA specifications is required to be formed of either natural rubber or synthetic natural rubber. Thus, the composition of the first piece 22 and second piece 24 may both be synthetic rubber, or may both be natural rubber, or the first piece 22 may be natural rubber and the second piece 24 may be synthetic rubber, and fall within the spirit of the present invention.

In addition, the composition of the first piece 22 and the second piece 24 may both be of the same general composition, but have varying compositions within this general classification and still fall within the spirit of the present invention. Thus, for example, the first piece 22 and second piece 24 could be formed of a synthetic rubber material having slightly varying positioning of pendent groups or atoms on the polymer chains, or chain lengths, or crosslinking, and still fall within the spirit of the present invention.

Moreover, and preferably, the color of the first piece 22 and the second piece 24 are different so as to create the distinctive colored regions 14, 18 representing a marking or markings visible to the user. Distinctive color regions are formed primarily by the introduction of pigments or dyes into the respective molten polymer materials 40, 54 prior to molding. However, as one of ordinary skill recognizes, subtle changes to the chemical structure of the respective molten raw materials 40, 54 may also achieve this desired result.

To form the second colored region 16 on the first piece 22, paint, ink or another coloring material 56 are applied to a portion 58 of the rounded outer surface 44 in a postproduction step. These coloring materials 56 are applied via spraying, dipping, brushing, or any other application technique known to an artisan of ordinary skill in the art.

As one of ordinary skill recognizes, the protrusions 17 and/or indentations 19 on the outer visible surface 20 of the ball 12 may also be introduced while forming the first 22 and/or second piece 24 by simply altering the shape of the respective molds 42, 48 prior to introduction of the respective molten raw materials 40, 54 used to form the respective pieces 22, 24. The shapes and size of these protrusions 17 or indentions 19, like the shapes and sizes of the pieces 22, 24, may vary greatly, depending upon the desired visible appearance of the outer surface 20 of the ball 12.

As one of ordinary skill appreciates, a sports ball that includes three or more pieces is easily attainable by slight modifications to the preferred method described above.

For example, a three-piece ball 58 could be made with a slight modification to the process described in FIGS. 3 and 4. Referring now to FIG. 5, the three-piece ball 58 is achieved by first forming the piece 60 in accordance with the pour molding method for forming piece 22 as described above in FIG. 3. Next, the first piece 60 is placed into in a substantially spherical pour mold 49 and contacts the outer circumference 57 of the mold 49. A second molten raw material 62 is then introduced, via pour molding, into the spherical mold 48 to partially fill the cavity 55 and allowed to cool, therein forming the second piece 64. Finally, a third molten raw material 66 is then introduced, via pour molding, into the spherical mold 49 to fill the cavity 55 and allowed to cool, therein forming a third piece 68 of the three-piece ball 58. Of course, as with the two-piece ball, an injection molding technique described in conjunction with FIGS. 3 and 4 above may be utilized in place of the pour molding technique described herein.

Similar to the two-piece ball 12 described above, the compositions of the each of the pieces 60, 64, 68 may be the same, or vary, as desired by the manufacturer. Moreover, and preferably, the color of the first piece 60 the second piece 64 and the third piece 68 are different so as to create the distinctive colored regions representing a marking or markings visible to the user. However, the color of any of the three pieces 60, 64, 68 may be the same and create the same effect.

Alternatively, as shown in FIG. 6, a three-piece ball 70 may be formed by first forming pieces 72 and 74 in accordance with the method for forming piece 22 as described above in FIG. 3. Next, pieces 72 and 74 are coupled to the outer circumference of the spherical injection mold 48 at different locations along its outer circumference 52. A third molten raw material 76 is then introduced, via injection molding, through ports 77 at a desired temperature and pressure into the spherical mold 48 to fill the cavity 50 and allowed to cool, therein forming a third piece 78 of the three-piece ball 70. Of course, as with the two-piece balls, a pour molding technique described in conjunction with FIGS. 3 and 4 above may be utilized in place of the injection molding technique described herein.

Similar to the three-piece ball 58 described above, the compositions of the each of the pieces 72, 74, 78 may be the same, or vary, as desired by the manufacturer. Moreover, and preferably, the color of the first piece 72, the second piece 74 and the third piece 78 are different so as to create the distinctive colored regions representing a marking or markings visible to the user. However, the color of any of the three pieces 72, 74, 78 may be the same and create the same effect.

As one of ordinary skill can envision, four-, five- and six- or more-piece balls may be formed by slightly altering the methods as described in FIGS. 5 and 6, preferably using either a pour molding or injection molding technique, with varied location, size, and shapes of the respective pieces. It will also be understood that a variety of other forming processes or techniques may be utilized

The visible outer surface portions of one or more of the pieces disclosed in conjunction with any of the preferred embodiments described in FIGS. 1-6 are ideal locations for markings 21 such as logos or other indicia having varying color schemes for a variety of purposes. For example, a multi-colored sports ball may be formed for use as a training aid to learn how to catch or throw. Moreover, these logos and other indicia may be used as source identifiers for manufacturers. Moreover, the logos or other indicia may be used in marketing or advertising the manufacturer's or others products, and therein provide a potential additional revenue stream for the manufacturer.

The introduction of these logos and other indicia, as molded in features, are also advantageous in that they do not adversely affect the roundness, and hence playability, of the sports balls by their introduction. Moreover, as these features are molded-in, they do not wear-off easily during use. Finally, because these logos and other indicia can be introduced with contrasting color schemes, they are especially prominent and visible to the user, especially compared to protrusions or indentions typically formed today on sports balls that are the same color.

While particular embodiments of the invention have been shown and described, numerous variations and alternate embodiments will occur to those skilled in the art. For example, other molding techniques other than pour molding or injection molding are specifically contemplated herein. Accordingly, it is intended that the invention be limited only in terms of the appended claims.

What is claimed is:

1. A method for forming a multi-piece sports ball, comprising:
forming a first piece having a rounded outer surface and an inner surface, said first piece being formed of a first composition and having a first color;
providing a substantially spherical mold having a substantially spherical inner cavity defining an outer circumference;
introducing said first piece to said substantially spherical mold such that said rounded outer surface is coupled to a corresponding portion of said outer circumference;
introducing a quantity of a molten raw material of a second composition to fill said substantially spherical inner cavity;
cooling said molten raw material within said cavity to form a second piece having a second color, said second piece being coupled to said inner surface of said first piece; and
removing said first piece and said second piece from said spherical mold.

2. A lacrosse ball formed in accordance with the method of claim 1.

3. The method of claim 1, wherein said first composition is the same as said second composition.

4. The method of claim 1, wherein said first composition is different than said second composition.

5. The method of claim 1, wherein said first color is the same as said second color.

6. The method of claim 1, wherein said first color is different than said second color.

7. The method of claim 1, wherein said first piece includes at least one protrusion formed along said rounded outer surface.

8. The method of claim 1, wherein said first piece includes at least one indention formed along said rounded outer surface.

9. The method of claim 7, wherein said second piece includes at least one protrusion formed thereon.

10. The method of claim 8, wherein said second piece includes at least one indention formed thereon.

11. The method of claim 1, wherein said first piece includes at least one protrusion and at least one indention formed along said rounded outer surface.

12. The method of claim 1 further comprising applying a coloring material to an outer surface of the lacrosse ball after removing said first piece and said second piece from said substantially spherical mold.

13. The method of claim 1 further comprising:
forming a third piece having a rounded outer surface and an inner surface, said third piece being formed of a third composition and having a third color; and
introducing said third piece to said substantially spherical mold such that said rounded outer surface is coupled to another corresponding portion of said outer circumference prior to introducing said quantity of said molten raw material of said second composition to fill said substantially spherical inner cavity.

14. The method of claim 1, wherein forming a first piece comprises pour molding a first piece having a rounded outer surface and an inner surface.

15. The method of claim 1, wherein forming a first piece comprises injection molding a first piece having a rounded outer surface and an inner surface.

16. The method of claim 1, wherein introducing a quantity of a molten raw material of a second composition to fill said substantially spherical inner cavity comprises pouring a quantity of a molten raw material of a second composition into said substantially spherical inner cavity to fill said substantially spherical inner cavity.

17. The method of claim 1, wherein introducing a quantity of a molten raw material of a second composition to fill said substantially spherical inner cavity comprises injecting a quantity of a molten raw material of a second composition into said substantially spherical inner cavity and a sufficient temperature and pressure to fill said substantially spherical inner cavity.

18. A method for forming a multi-piece sports ball, comprising:
providing a substantially spherical mold having a substantially spherical inner cavity defining an outer circumference;
introducing a first quantity of a molten raw material of a first composition into said substantially spherical inner cavity;
cooling said first quantity of said molten raw material within said cavity to form a first piece having a first color;
introducing a second quantity of a molten raw material of a second composition into said substantially spherical inner cavity;
cooling said second quantity of said molten raw material within said cavity to form a second piece having a second color, said second piece being coupled to said inner surface of said first piece; and
removing said first piece and said second piece from said spherical mold.

19. The method of claim 18, further comprising:
introducing a third quantity of a molten raw material of a third composition within said substantially spherical inner cavity prior to removing said first piece and said second piece from said spherical mold;
cooling said third quantity of said molten raw material within said cavity to form a third piece having a third color, said third piece being coupled to an inner surface of said second piece; and
removing said first piece and said second piece and said third piece from said spherical mold.

20. A lacrosse ball formed in accordance with the method of claim 18.

21. The method of claim 18, wherein said first composition is the same as said second composition.

22. The method of claim 18, wherein said first composition is not the same as said second composition.

23. The method of claim 18, wherein said first color is the same as said second color.

24. The method of claim 18, wherein said first color is different than said second color.

25. The method of claim 18, wherein said first piece includes at least one protrusion formed along said rounded outer surface.

26. The method of claim 18, wherein said first piece includes at least one indention formed along said rounded outer surface.

27. The method of claim 18, wherein said second piece includes at least one protrusion formed thereon.

28. The method of claim 18, wherein said second piece includes at least one indention formed thereon.

29. The method of claim 18, wherein said first piece includes at least one protrusion and at least one indention formed along said rounded outer surface.

30. The method of claim 18 further comprising:
applying a coloring material to an outer surface of the lacrosse ball after removing said first piece and said second piece from said substantially spherical mold.
